(19) United States
(12) Patent Application Publication
(10) Pub. No.: US 2025/0109697 A1
(43) Pub. Date: Apr. 3, 2025

(54) POWER PLANT WITH WATER VAPOR SEPARATION MEMBRANE

(71) Applicant: Mitsubishi Power Americas, Inc., Lake Mary, FL (US)

(72) Inventor: Shimin Deng, Oakville (CA)

(21) Appl. No.: 18/376,073

(22) Filed: Oct. 3, 2023

(51) Int. Cl. F01K 23/10; F01K 11/02

(52) U.S. Cl. CPC F01K 23/106; F01K 11/02; F05D 2220/72; F05D 2300/43

(57) ABSTRACT

A power production facility comprises a combined cycle power plant comprising a gas turbine engine configured to combust a fuel to produce a gas that can be used to produce rotational shaft power for generating electricity and a steam system configured to produce steam with the gas, and a vapor separation membrane positioned in the gas to separate water vapor from the gas. A method of recovering water from a gas turbine combined cycle power plant comprises operating a gas turbine engine to produce electrical power with a gas, generating steam from a water supply with the gas using a steam system, capturing water vapor from the gas to produce captured water using a water vapor separation membrane, and returning at least a portion of the captured water to the water supply.

### TECHNICAL FIELD

This document pertains generally, but not by way of limitation, to gas turbine power plants that can operate in conjunction with steam systems. More specifically, but not by way of limitation, the present application relates to systems and methods for recovering water from exhaust gas by operation of gas turbine power plants that operate in conjunction with exhaust gas systems.

### BACKGROUND

In a gas turbine power plant, a gas turbine engine can be operated to directly generate electricity with a generator using shaft power. Compressed air and fuel can be combusted to produce high energy gas to rotate a turbine of the gas turbine engine. The turbine can be used to drive a compressor to produce the compressed air and an electrical generator to produce electricity.

In simple cycle operation of a gas turbine engine power plant, after use in the turbine, the high energy gas becomes exhaust gas that is typically vented to atmosphere, sometimes with the use of systems for altering constituents of the exhaust gas, such as carbon monoxide and nitric oxide. However, gas turbine operation can be combined with a steam bottoming cycle or steam system. The steam system can be used to generate steam that can be used to drive a steam turbine that can be used to generate electricity. Steam systems for simple cycle gas turbine operation can typically comprise a single-circuit heat recovery steam generator (HRSG) where the steam production and operation can be operated in associated with the Brayton cycle of the gas turbine engine. A steam system for combined-cycle power plants can typically comprise a multi-circuit HRSG operating a Rankine cycle in combination with the Brayton cycle. Working fluid for the GTCC typically comprises air and gas (topping cycle) and steam and water (bottoming cycle), and a gas or liquid fuel is burned in the gas turbine engine.

### Overview

The present inventor has recognized, among other things, that problems to be solved in the operation of steam systems with gas turbine engines involve one or both of excessive consumption of water and increased cost and complexity associated with additional capital equipment.

The present inventor has recognized that steam injected into the gas turbine engines is typically lost as the exhaust gas is vented to atmosphere. Attempts have been made to increase the output of gas turbine power plants using steam injection. Steam can be injected into the combustor of the gas turbine to increase the flow rate of the high energy gas to increase the output of the turbine. However, since the injected steam is commonly vented to the atmosphere with the exhaust gas, steam injection systems must typically be located proximate a large source of available water.

The present inventor has also recognized that previous attempts to recover water from steam injection systems have involved the use of expensive and energy intensive equipment. For example, dedicated condensers can be placed in the exhaust gas stream to recover water vapor present therein. The condenser can include a heat exchanger having a fluid, such as a coolant, circulating therethrough that condenses moisture from the exhaust gas. However, the capital equipment required to build such systems is expensive. Furthermore, operation of the condenser requires the consumption of additional auxiliary loads, thereby reducing the efficiency of the power plant.

The present subject matter can provide solutions to these problems and other problems, such as by using steam injection in combination with vapor separation membranes. The combination of vapor separation membranes with steam injection can allow for the use of steam injection in combined-cycle power plants, thereby increasing the overall output of the power plant. Furthermore, vapor separation membrane technology can be used to recover water from exhaust gas of a combined-cycle power plant. The recovered water can be recycled into the steam system so that the power plants need not be located near a body of water, and the environmental impact of such systems is reduced. Furthermore, the recovered water can be used for other operations, if desired, such as the operation of electrolyzers, for generating fuel for the gas turbine engine, or other purposes.

In an example, a power production facility can comprise a combined cycle power plant comprising a gas turbine engine configured to combust a fuel to produce a gas that can be used to produce rotational shaft power for generating electricity and a steam system configured to produce steam with the gas, and a vapor separation membrane positioned in the gas to separate water vapor from the gas.

In another example, a method of recovering water from a gas turbine combined cycle power plant, the method can comprise operating a gas turbine engine to produce electrical power with a gas, generating steam from a water supply with the gas using a steam system, capturing water vapor from the gas to produce captured water using a water vapor separation membrane, and returning at least a portion of the captured water to the water supply.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 is a schematic diagram of a gas turbine combined cycle power plant of the present disclosure having a water vapor separation membrane and a steam injection system.

FIG. 2 is a schematic diagram of a steam injection simple cycle of the present disclosure incorporating a water vapor separation membrane.

FIG. 3 is a line diagram illustrating operations of methods for recovering water from exhaust gas in power plants and using the collected water for steam injection and other purposes according to various aspects of the present disclosure.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

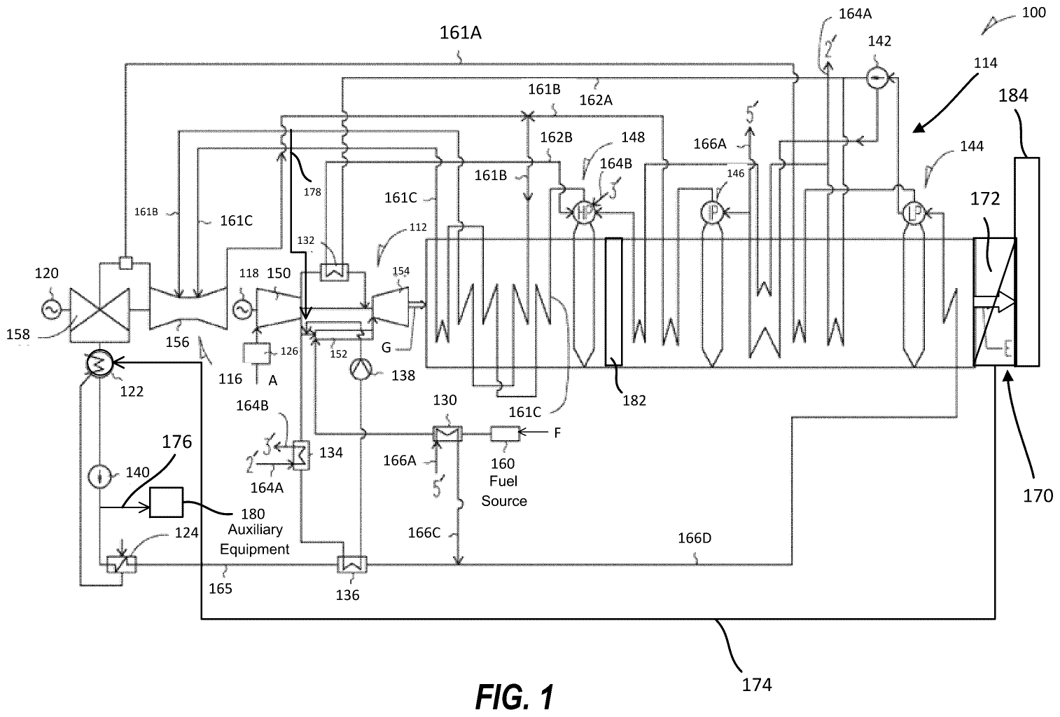

FIG. 1 is a schematic diagram illustrating Gas Turbine Combined Cycle (GTCC) power plant 100 having gas turbine engine (GTE) 112, Heat Recovery Steam Generator (HRSG) 114 and steam turbine 116. Power plant 100 can comprise a power production facility that provides electrical power to a power grid. GTE 112 can be used in conjunction with electrical generator 118, and steam turbine 116 can be used in conjunction with electrical generator 120. Power plant 100 can also include condenser 122 and gland steam condenser (GSC) 124, evaporative cooler 126, fuel gas heater 130, Turbine Cooling Air (TCA) cooler 132, Enhanced Cooling Air (ECA) coolers 134 and 136, enhanced cooling air compressor 138, condensate pump 140 and feedwater pump 142. HRSG 114 can comprise a 3-stage heat recovery steam generator including low pressure section (stage) 144, intermediate pressure section (stage) 146 and high pressure section (stage) 148. GTE 112 can include compressor 150, combustor 152 and turbine 154. Steam turbine 116 can include IP/HP spool 156 and LP spool 158.

Power plant 100 can further include water recovery system 170. Water recovery system 170 can comprise membrane 172, recovery line 174, water output line 176 and injection line 178. Power plant 100 can additionally include auxiliary equipment 180 that can utilize water recovered from HRSG 114. As discussed herein, auxiliary equipment 180 can be implemented due to inclusion of membrane 172. Auxiliary equipment 180 can be used in conjunction with injection line 178. In examples, injection line 178 can be provided with valves to selectively open or close that line to allow or prevent flow therethrough. In examples, auxiliary equipment 180 can comprise one or more electrolyzers to convert water recovered by membrane 172 into hydrogen gas and oxygen gas utilizing an electricity input. Auxiliary equipment 180 can additionally comprise other consumers of water, such as an industrial, commercial or residential process. As discussed herein, the amount of water separated from exhaust gas E can be greater than the amount of water injected at injection line 178 due to the presence of moisture in the high energy gases generated in the combustor. As such, water is typically removed from system at water output line 176. Thus, in examples, water can be removed at water output line 176 for water balancing purposes without the use of auxiliary equipment 180.

Ambient air A can enter compressor 150 through evaporative cooler 126. The compressed air is fed to combustor 152 and mixed with fuel F from fuel source 160, which can be a source of natural gas, re-gasified LNG or hydrogen (H2) gas. The compressed air from compressor 150 is mixed with the fuel for combustion in combustor 152 to produce high energy gas for turning turbine 154. Rotation of turbine 154 is used to produce rotational shaft power to drive compressor 150 and electrical generator 118. The high energy gas can exit turbine 154 as exhaust gas G and can be directed to HRSG 114, where exhaust gas G interacts with appropriate water/steam piping in high pressure section 148, intermediate pressure section 146 and low pressure section 144 to produce steam before eventually becoming exhaust gas E. The steam is routed to IP/HP spool 156 and LP spool 158 of steam turbine 116 via steam lines 161C, 161B and 161A to produce rotational shaft power to operate electrical generator 120. HRSG 114 can additionally include appropriate means for conditioning exhaust gas E to remove potentially undesirable materials. For example, HRSG 114 can include systems and devices for removing undesirable materials from exhaust gas E, such as Selective Catalytic Reduction (SCR) emissions reduction units. HRSG 114 can include emissions reduction unit 182.

Exhaust gas E can exit HRSG 114 utilizing any appropriate venting means, such as stack 184. As discussed in greater detail below, membrane 172 can be positioned at the outlet of HRSG 114, such as before stack 184, to recover water from exhaust gas E before exhaust gas E is vented to atmosphere. As such, high energy gas can be generated in combustor 152 to rotate turbine 154, which can reduce the energy of the gas. The reduced energy gas can pass into HRSG 114 as exhaust gas G. HRSG 114 can reduce the temperature of the exhaust gas so that exhaust gas E is generated near or at the outlet of HRSG 114 for venting to stack 184. Thus, the composition of the gas flow can remain the same from combustor 152 to stack 184, but the energy and temperature of the gas can change. In examples, a duct burner can be used wherein the composition and temperature of the exhaust gas from turbine 154 can be altered to facilitate steam production in HRSG 114.

Water that is used in HRSG 114 can be used as a cooling source in TCA cooler 132 and ECA coolers 134 and 136. TCA cooler 132 and ECA coolers 134 and 136 can utilize water from HRSG 114 to cool compressed air extracted from compressor 150 to cool components of combustor 152 and turbine 154. For example, water from low pressure section 144 can be supplied by feedwater pump 142 to TCA cooler 132 via line 162A and returned to high pressure section 148 via line 162B. Likewise, water from feedwater pump 142 can be supplied to ECA cooler 134 via line 164A, as is shown by arrows 2′-2′, which can then be returned to high pressure section 148 via line 164B, as is shown by arrows 3′-3′. Water from GSC 124, via line 165, can also be provided to ECA cooler 136 to cool the compressed air.

Water from HRSG 114 can also be used to perform fuel heating at fuel gas heater 130 with water line 166A, as is shown by arrows 5′-5′, and water can then be returned to low pressure section 144 via lines 166C and 166D.

Membrane 172 can be positioned within HRSG 114, downstream of HRSG 114, or upstream of stack 184. Furthermore, membrane 172 can be positioned downstream of emissions reduction unit 182. Membrane 172 can be positioned anywhere in HRSG 114 in various examples. Membrane 172 can be positioned proximate stack 184 where temperatures are lower. Emissions reduction unit 182 is typically positioned at the upstream (relative to flow of exhaust gas E) portion of HRSG 114 near the high pressure and intermediate pressure stages where temperatures are more conducive for chemical reactions.

Membrane 172 can be used to recover water from exhaust gas E. In examples, membrane 172 can be used to separate H2O molecules within exhaust gas E from the other contents of exhaust gas E. In examples, membrane 172 can comprise a water vapor separation membrane, such as a homogeneous hydrophobic membrane or a composite hydrophobic and hydrophilic membrane. In examples, membrane 172 can comprise a polypropylene (PP) or polyvinylidenedifluoride (PVDF) membrane. In examples, membrane 172 can comprise a vapor-selective membrane. In examples, a vapor-selective membrane can comprise a polymer layer and hygroscopic layer. In examples, a vapor-selective membrane can comprise Polyvinyl alcohol (PVA) combined with one or both of LiCl and triethylene glycol (TEG). In examples, membrane 172 can comprise a vapor-selective membrane as described in Andrew J. Fix, James E. Braun, David M. Warsinger, Vapor-selective active membrane energy exchanger for high efficiency outdoor air treatment, Applied Energy, Volume 295, 2021, the contents of which are hereby incorporated by reference.

In examples, multiple instances of membrane 172 can be used to cover the cross-sectional area of the flow path of exhaust gas E, such as the cross-sectional area of HRSG 114 or stack 184. In examples, a plurality of instances of membrane 172 can be positioned in series within the flow of exhaust gas E to so that exhaust gas E passes through multiple membranes, thereby sequentially removing water content from exhaust gas E.

The H2O molecules separated from membrane 172 can be in a gas state. Recovery line 174 can be fluidly connected to membrane 172 to allow the collected steam to be utilized. The gaseous water vapor collected from membrane 172 can be piped to the steam side of condenser 122 through a steam pipe comprising recovery line 174. The gaseous water vapor can be combined with exhaust steam of the turbine of LP spool 158 and condensed into water in condenser 122. The majority of the condensed water from condenser 122 can be pumped by condensate pump 140 for recycling to the steam cycle. Extra condensed water can be extracted from the steam cycle via water output line 176. In examples, a pressure differential can exist between condenser 122 and separated water vapor such that water vapor from recovery line 174 can be drawn into condenser 122. The partial pressure of the water vapor content of exhaust gas E can be greater than the pressure within condenser 122 to draw water vapor from membrane 172 to condenser 122 where the water vapor can be condensed to water. Stated another way, the chemical gradient, to drive the vapor out of exhaust gas E across membrane 172 to the permeate side, can be created by pressure difference between vapor partial pressure of the feed side and the permeate side (vacuum pressure of the condenser 122). A dedicated condenser for creating the chemical gradient is not required.

In particular, the steam system including the HRSG 114 can include injection line 178 that can utilize steam from within HRSG 114 for injection into GTE 112. In examples, a portion of the hot-reheat steam in line 161B that would otherwise be used to drive IP/HP spool 156 can be injected into GTE 112. Steam from intermediate pressure section 146 can be configured to match pressures within combustor 152. However, steam can be injected into GTE 112 from other locations, such as low pressure section 144 and high pressure section 148. The steam can be injected into GTE 112 using appropriate injectors, nozzles or the like. In examples, steam can be injected into combustor 152. However, steam can be injected into GTE 112 in other locations than combustor 152, such as upstream of turbine 154. Steam injected into the combustion process within combustor 152 can increase the mass of the generated high energy gas to increase the capability of driving turbine 154. The steam can continue with exhaust gas G through HRSG 114 as exhaust gas E where, after being used to boil water for steam turbine 116, the steam can exit HRSG 114, and is separated/captured through membrane 172 before stack 184.

Typically, a conventional HRSG can operate in a closed-loop fashion without a steam injection system such that water can be continuously vaporized and condensed for use with a steam turbine. However, the introduction of steam injection removes water from the closed-loop system such that steam is consumed and water in the HRSG needs to be made up/replaced. As such, continuous operation of the steam injection system requires a steady supply of make-up water, often more than is what available without impacting plant operation cost and the environment.

Water injected into GTE 112 exits HRSG 114 and would otherwise exit power plant 100 altogether, that is, be consumed, without the use of membrane 172. Membrane 172 can be used to close the system of a HRSG that is otherwise open and allows the environmental escape of water used for steam injection. In examples, one or more of membrane 172 can recover more than the water used by the steam injection. In particular, membrane 172 can recover water injected at injection line 178, as well as water that is generated in the combustion process of burning fuel F. Thus, water vapor obtained from membrane 172 and collected in recovery line 174 can be returned to the steam system to compensate for water provided at injection line 178. In examples, water in recovery line 174 can be equal to the amount of water in injection line 178 and water output line 176. In example, water in water output line 176 can be approximately equal to the amount of water content created by burning fuel F. In examples, membrane 172 can be configured to recover less water than is injected at injection line 178, such as to accommodate water generated in the combustion process to produce a closed loop system. For example, membrane 172 can be configured to cover less than the entire cross-sectional area of HRSG 114. Thus, a closed loop system can be formed where water extracted at recovery line 174 is equal to the amount of water in injection line 178 and generated during combustion, with some water vapor being carried away in exhaust gas E and no excess water being recovered. Thus, in examples, water output line 176 can be omitted. In examples, water generated by the combustion process that is recovered by membrane 172 can accommodate for deficiencies in membrane 172, such as if membrane 172 cannot recover 100% of water vapor passing therethrough due to, for example, wear or other factors. In examples, steam injection at injection line 178 can be turned off and water can be extracted from system 100 due to water generated during combustion. In examples, water recovery system 170 can operate (associated with condenser 122) to recycle water into HRSG 114 such that, with respect to water, HRSG 114 and water recovery system 170 can operate in a closed-loop fashion, with exhaust gas E operating in an open loop.

To illustrate operation of power plant 100, description of examples of operating conditions are provided wherein various water or water vapor flows can be balanced in various operating states. Under normal operating conditions, water vapor extracted at recovery line 174 can be equal to or approximately equal to water in output line 176 and injection line 178. In a non-injecting mode, with a valve on injection line 178 closed, water vapor in recovery line 174 can be equal to or approximately equal to water in output line 176. In examples of insufficient water recovery, such as where water vapor in recovery line 174 is less than water in injection line 178 and water in output line 176 is equal to zero, makeup water can be added to power plant 100 to maintain mass balance. The makeup water can be added into condenser 122. Alternatively, flow in injection line 178 can be lowered to equal output of water vapor at recovery line 174, without inclusion of makeup water.

Water recovery by membrane 172 can enable other features of power plant 100 and HRSG 114. As mentioned, membrane 172 can recover water to HRSG 114 for steam injected into GTE 112. In examples, extra water from HRSG 114 (from fuel-generated water vapor in the combustor, for example) can be extracted at water output line 176 for use with other equipment, systems, and devices, such as auxiliary equipment 180. In examples, auxiliary equipment 180 can comprise an electrolyzer plant. The electrolyzer system can comprise one or more electrolyzers for converting water (H2O) into its constituent components (H2 and O2). In examples, the H2 can be provided to GTE 112 as fuel for combustor 152.

Operation of power plant 100 and HRSG 114 with membrane 172 was simulated to determine the feasibility and benefits of such a system. In examples, power plant 100 was modeled using GTPro software.

In examples, GTE 112 can comprise a 2-on-1 configuration having two gas turbine engines and two HRSGs working with one steam turbine 116. The 2-on-1 GTCC can have a typical steam bottoming cycle featuring three pressure levels (HP, IP and LP) with reheat. The cooling system can have a wet surface condenser with a mechanical draft cooling tower. The major assumed parameters of the steam bottoming cycle are listed in Table 1.

TABLE 1
Assumptions of Steam Bottoming Cycle of GTCC

| | | |
|---|---|---|
| HP Steam Pressure at ST Inlet | Bar | 151.7 |
| HP Steam Temperature/ | ° C. | 566 |
| Hot Reheat Temperature at ST Inlet | | |
| IP Steam Pressure at ST Inlet | Bar | 34.5 |
| LP Steam Pressure at ST Inlet | Bar | 6.1 |
| ΔTpp of HRSG | ° C. | 8.3 |
| ΔTapp of HRSG | ° C. | 5.6 |
| Condenser Pressure | kPa | 4 |

HP steam temperature/hot reheat temperature at ST inlet for the present disclosure can be lower than 566° C. due to lower gas turbine exhaust temperature caused by steam injection. In examples, F-class gas turbines are selected for the simulation as gas turbine performance with water injection, utilizing a 12% steam-to-air ratio, is available from public domain. The simulations can be based on International Organization for Standardization (ISO) ambient conditions, namely 1.013 bar, dry bulb temperature of 15° C., and relative humidity of 60%. F-class gas turbines can be simulated using user-defined model that matches data by the vendors.

Two options were simulated, and the calculation results are illustrated in Table 2.

TABLE 2
Performance Data of Power Plant

| | GTCC | New Concept |
|---|---|---|
| GT Output, MW | 418.8 | 729.3 |
| ST Output, MW | 236.2 | 106.9 |
| Extra Losses | — | 2.5 |
| Power Train Gross output, MW | 655.0 | 833.7 |
| GT Heat Input, MWth LHV | 1109.9 | 1398.5 |
| Power Train Gross Efficiency, LHV | 59.0% | 59.6% |
| Water Recovered, t/h | — | 560 |
| Water Addition to GTs, t/h | — | 433 |
| Water Byproduct, t/h | — | 127 |

The column on the left labeled “GTCC” represents a conventional gas turbine combined cycle power plant. The column on the right labeled “New Concept” represents an example system of the present disclosure. Extra losses for the New Concept can comprise losses from additional gas turbine exhaust pressure loss by the presence of membrane 172 as well as additional auxiliary loads of cooling water pumps and cooling tower fans. Additionally, the calculation of membrane 172 is based on vapor partial pressure in flue gas of 5.5 kPa/pressure at the permeate side of 5 kPa, respectively, and pressure loss of steam pipe from membrane 172 to condenser of 20% (5 kPa vs. 4 kPa).

The systems, devices and methods of the present disclosure can achieve a significant performance improvement that can be achieved by the application of vapor separation membranes, e.g., membrane 172, in a steam-injection GTCC power plant. As presented in Table 2, the benefits of the New Concept of the present disclosure include 1) 179 megawatts (MW) more output, 2) an increase in efficiency by 0.6% points (58 Btu/kWh heat rate improvement) and 3) 127 t/h water byproduct. Further, the simulations discussed above show improvement of 2×1 GTCC power plant in lower capital cost in $/kW. The present disclosure achieves benefits using F-class gas turbines (˜200 MW range) due to, for example, availability of steam-injection gas turbine performance, and it is anticipated that the aforementioned benefits could be greater if advanced-class gas turbines (˜>400 MW range) are used.

The cost increase for application of water vapor separation membranes with gas turbine combined cycle power plants would be the cost of the water vapor separation membrane unit, the cost of related pipelines and potentially the cost of gas turbine modification due to steam injection. Cooling system capacity could be larger than the traditional gas turbine combined cycle power plant for the same gas turbine model, which leads to incremental costs on condenser, etc.

The steam turbines used in the present disclosure can be custom designed as a large portion of the intermediate pressure steam would likely be taken out for sending to the gas turbine engine, and the IP/LP turbine output is correspondingly smaller. Therefore, the impact on the steam turbine cost would be limited.

The sum of the above items for cost increase would be insignificant compared to benefits of the present disclosure, particularly over the long term.

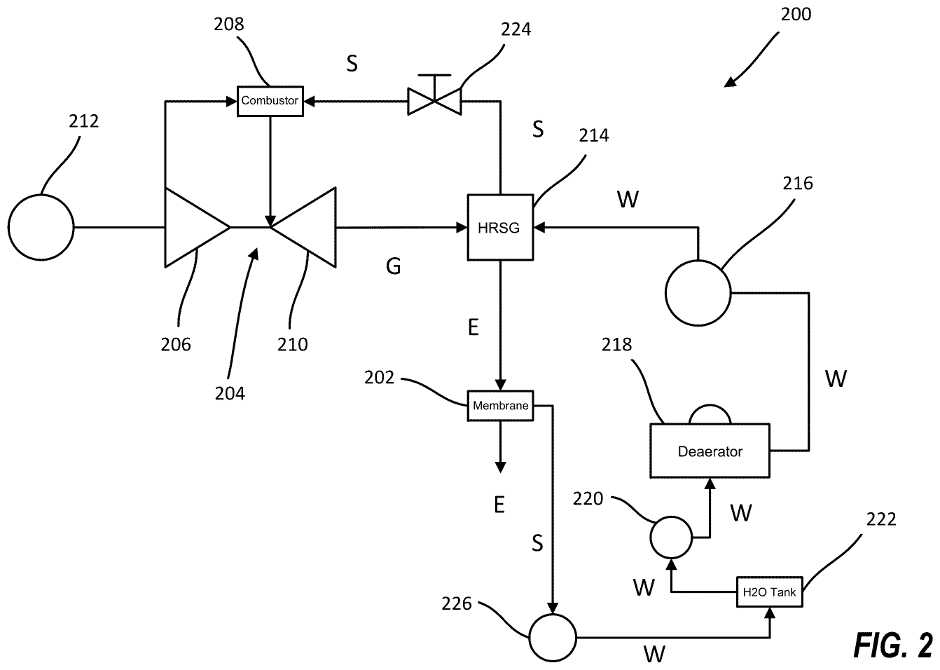

FIG. 2 is a schematic diagram of a steam injection simple cycle 200 incorporating membrane 202. Steam injection simple cycle 200 can comprise gas turbine engine 204 comprising compressor 206, combustor 208 and turbine 210, electrical generator 212, HRSG 214, pump 216, deaerator 218, pump 220, water tank 222, condenser 226 and valve 224.

Gas turbine engine 204 can be operated to generate exhaust gas G. Operation of gas turbine engine 204 can cause rotation of compressor 206 and turbine 210, as well as electrical generator 212 in order to produce electrical power. Gas turbine engine 204 can be operated in a similar manner as GTE 112 of FIG. 1 to combust a fuel and air to produce high energy gas to rotate turbine 210, which can then drive compressor 206 and produce shaft power for operating electrical generator 212.

Exhaust gas G can pass into HRSG 214 to become exhaust gas E. HRSG 214 can also receive water from water tank 222 through operation of pump 220, deaerator 218 and pump 216. Water tank 222 can receive water from a body of water, such as a lake, river or ocean, or a municipal water supply (after treatment). Pump 220 can move water from water tank 222 to deaerator 218. Deaerator 218 can be configured to remove dissolved gases from water in water tank 222 that can potentially comprise corrosive gases. Pump 216 can move water from deaerator 218 to HRSG 214.

Water from water tank 222 can be evaporated, e.g., increased in temperature, within HRSG 214 to produce steam S. Steam S can be provided to combustor 208 when valve 224 is opened. As previously explained, the presence of steam S can increase the mass of high energy gas to turbine 210 to increase the overall output of steam injection simple cycle 200.

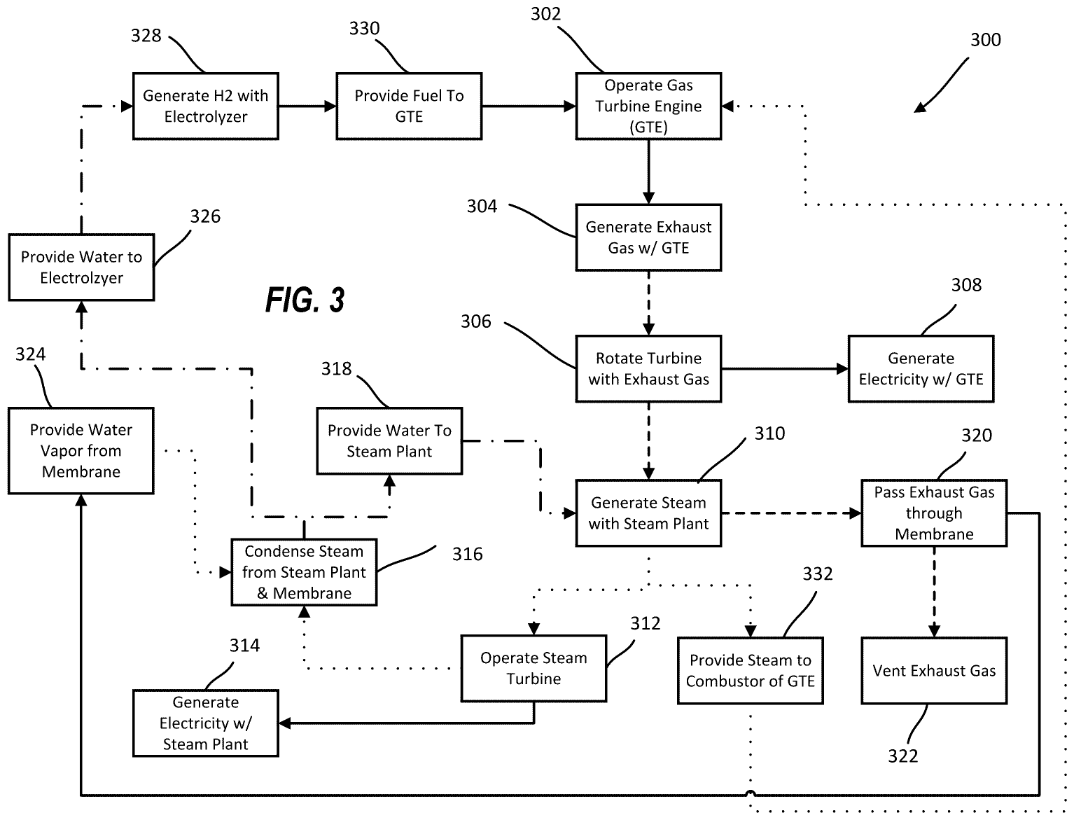

After passing through HRSG 214, exhaust gas E can pass through membrane 202. Membrane 202 can be used to extract water vapor from exhaust gas E. Membrane 202 can operate similarly to membrane 172 of FIG. 1. Water vapor extracted from exhaust gas E can be condensed in a condenser 226 (with associated vacuum system and condensate pump) and then collected in water tank 222. Water tank 222 can include a water extraction line to remove water from steam injection simple cycle 200 to, for example, balance the water supply because membrane 202 can remove water generated within combustor 208 in addition to water from injection. As such, water usage in steam injection simple cycle 200 can form a closed-loop system. Exhaust gas E can leave membrane 202 and can be vented to atmosphere. HRSG 214 can include an emissions reduction unit similar to emissions reduction unit 182. Additionally, water from membrane 202 can be collected for other uses as an alternative to steam injection or to operate with steam injection, such as to provide an input to an electrolyzer, as explained with reference to FIGS. 1 and 3.

FIG. 3 is a line diagram illustrating operation 302 to operation 330 of method 300 for injecting steam into a gas turbine engine and extracting water from exhaust gas of the gas turbine engine. Though discussed with reference to HRSG 114 and power plant 100 of FIG. 1, method 300 can encompass the use of any steam system, such as a once-through steam generator. Method 300 can additionally include fewer or greater operations than other operation 302 to operation 330 and operation 302 to operation 330 can be performed in other sequences. FIG. 3 utilizes dashed lines to show exhaust gas operations, dotted lines to show steam operation, dash-dot lines to show water operations and solid lines for fuel, mechanical, electrical or other operations for visualization purposes. However, all lines are intended to indicate movements between operations of method 300, and exhaust, water, steam, electrical, mechanical and other operations can occur at any or all operations.

With reference to FIG. 3 in conjunction with FIG. 1, at operation 302, GTE 112 can be operated. Air A and fuel F can be provided to combustor 152 to be burned to produce high energy gases. A single gas turbine engine is illustrated in FIG. 1, but more than one of GTE 112 can be used, such as in a two-by-one configuration where two gas turbine engines operate with one steam turbine.

At operation 304, high energy gas can be generated by GTE 112 by the combustion of air A and fuel F. Combustion of air A and fuel F can produce high energy gas that can be used to perform work. As discussed with reference to operation 332, the mass of high energy gas can be increased via injection of steam into the production or flow at outlet of the combustor. The high energy gas can exit turbine 154 as exhaust gas G and can flow into HRSG 114 to produce steam for steam turbine 116, flow through emissions reduction unit 182, flow through membrane 172 and out stack 184.

At operation 306, high energy gas can be used to drive GTE 112 and the outlet gas from GTE 112 is exhaust gas G. Operation of GTE 112 can be used to generate rotational shaft power that can be used to drive compressor 150 and electrical generator 118.

At operation 308, electricity can be produced with electrical generator 118 by the rotation of GTE 112. Compressor 150 can be mechanically linked to electrical generator 118 by a shaft. Electrical generator 118 can be used to generate electricity for providing to a power grid.

At operation 310, exhaust gas G can be used to generate steam from water in a steam system. In examples, the steam system can comprise HRSG 114 of FIG. 1. In examples, the steam system can comprise HRSG 214 of FIG. 2. The steam system can comprise other systems and devices for generating steam, such as a once through steam generators, firetubes, watertubes, condensing, electric resistance boilers and the like.

At operation 312, the steam generated at operation 310 can be used to operate steam turbine 116. Steam turbine 116 can be rotationally driven by a flow of steam to produce rotational shaft power.

At operation 314, electricity can be produced with electrical generator 120 by the rotation of steam turbine 116. Steam turbine 116 can be mechanically linked to electrical generator 120 by a shaft. Electrical generator 120 can be used to generate electricity for providing to a power grid.

At operation 316, steam/water vapor can be collected from the steam turbine operating at operation 312 and from the membrane operating at operation 324. The collected steam can be condensed into water at condenser 122 and collected for reuse. Water can be circulated throughout HRSG 114 using appropriate piping and pumps, such as condensate pump 140 and feedwater pump 142. Water can also be provided to external equipment, such as electrolyzers at operation 326. In examples, the collected water can be flowed to condenser 122, such as via pressure differential between membrane 172 (high pressure) and condenser 122 (low pressure).

At operation 318, the water collected at operation 316 can be provided to the steam system. The collected water can be heated to produce steam using low pressure section 144, intermediate pressure section 146 and high pressure section 148 of HRSG 114 to provide a continuous flow of steam to steam turbine 116. As such, the steam system can operate as closed-loop system of generating steam, condensing the steam into water after use, and boiling the collected water to generate more steam. However, as discussed herein, excess water can be removed from the system to maintain a balanced water supply due to the production of water in the combustion process

At operation 320, exhaust gas E after generating steam at operation 310 can be passed through a membrane, such as membrane 172 of FIG. 1 or membrane 202 of FIG. 2. Exhaust gas G from GTE 112 can be passed into a duct of HRSG 114 as exhaust gas E and to membrane 172. In examples, the membrane can comprise a vapor-selective membrane configured to prevent the passage of H2O molecules therethrough, while allowing other components such as air (e.g., O2, N2) and other products of combustion to pass therethrough.

At operation 322, exhaust gas E can be vented to atmosphere after passing through stack 184. Emissions reduction unit 182 can be located in HRSG 114. Emissions reduction unit 182 can be configured to remove undesirable materials from exhaust gas E, such as NOX, CO, CO2 and the like.

At operation 324, steam can be separated from exhaust gas E using membrane 172 at operation 320. Steam from membrane 172 can be routed through appropriate piping to a condenser.

At operation 326, some or all of the water collected by the membrane can be provided to an auxiliary system, such as one or more electrolyzers. Water can be provided to auxiliary equipment 180 via water output line 176. In examples, auxiliary equipment 180 can comprise one or more electrolyzers. However, auxiliary equipment 180 can comprise other items, such as industrial processes.

At operation 328, auxiliary equipment 180 can be operated. As discussed, auxiliary equipment 180 can comprise electrolyzers that can utilize alkaline electrolyzer technology to achieve electrolysis of water to produce hydrogen and oxygen using a solid oxide, or ceramic electrolyte. A single electrolyzer is illustrated in FIG. 1, but more than one electrolyzer can be used. The electrolyzer can consume water recovered from exhaust gas E of HRSG 114 to produce constituent components of H2 and O2. Electricity can be provided to the electrolyzer by a power source, one or more renewable energy sources such as wind, solar and hydro, the grid or electrical generator 118 and electrical generator 120. The produced H2 and O2 gas can be stored or compressed or otherwise transported to a location for use or storage. If desired, makeup water or water from an external source can be added to power plant 100 at various locations. In examples, water can be added at the electrolyzers or to the steam system at various locations.

At operation 330, fuel F can be provided to GTE 112. In examples, fuel F can comprise 100% natural gas. In examples, fuel F can comprise about 50% to about 70% natural gas, with the balance comprising hydrogen (112). Hydrogen from the electrolyzer of operation 328 can be provided to GTE 112 as fuel F.

At operation 332, steam can be provided to GTE 112 used at operation 302. The steam can be injected into combustor 152 to be mixed with air A and fuel F used in the combustion process. In examples, the steam can be injected into the combustor of GTE 112. The steam can be used to increase the mass of high energy gas to increase the power output of turbine 154, reduce specific fuel consumption and reduce NOx generation. As such, overall performance of power plant 100 can be achieved as discussed above.

The systems and methods of the present disclosure can achieve numerous benefits by combining water vapor separation membranes with steam injection in gas turbine engine power plants that operate with a steam system. As discussed herein, steam injection can increase overall power output of power plant 100 via steam injection. Water from steam system consumed during the steam injection can be recaptured using membrane 172, thereby forming a closed-loop system. Steam injection and vapor separation membranes can therefore function in a synergistic manner to increase power output of power plant 100 while reducing demands placed on local water supplies. Furthermore, extra water recaptured with the vapor separation membrane, as is available from water generated by the combustion process, can additionally or alternatively be used with other equipment, such as electrolyzers, to generate fuel for the gas turbine engine, thereby converting water resources to a fuel resource.

### Various Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A power production facility comprising:
a combined cycle power plant comprising:
a gas turbine engine configured to combust a fuel to produce a gas that can be used to produce rotational shaft power for generating electricity; and
a steam system configured to produce steam with the gas;
a vapor separation membrane positioned in a flow of the gas to separate water vapor from the gas;
a condenser positioned outside of the flow of the gas; and
a steam injection system to deliver water from the steam system to a combustor of the gas turbine engine, wherein the water captured with the vapor separation membrane is recycled to the steam injection system;
wherein a pressure differential can be produced between the condenser and water vapor separated by the vapor separation membrane such that the separated water vapor can be drawn into the condenser.

2. The power production facility of claim 1, wherein the vapor separation membrane comprises a vapor-selective membrane.

3. The power production facility of claim 2, wherein the vapor separation membrane comprises a polymeric layer combined with a hygroscopic material.

4. (canceled)

5. (canceled)

6. The power production facility of claim 1, wherein the steam produced by the steam system is used to rotate a steam turbine for generating additional electricity.

7. The power production facility of claim 6, wherein the steam system comprises a 3-stage heat recovery steam generator having a low-pressure stage, a medium-pressure stage and a high-pressure stage, wherein steam is drawn from the medium-pressure stage for the steam injection system.

8. The power production facility of claim 1, wherein the steam system comprises a steam injection simple cycle, the steam injection simple cycle comprising:
a HRSG to heat water from a water supply with gas of the gas turbine engine; and
an injector to introduce steam from the HRSG into a combustor for the gas turbine engine.

9. The power production facility of claim 1, further comprising a water extraction line to send at least a portion of water captured with the vapor separation membrane to an external consumer of water.

10. The power production facility of claim 9, wherein the external consumer of water comprises an electrolyzer, wherein at least a portion of the water captured from the gas is delivered to the electrolyzer.

11. A method of recovering water from a gas turbine combined cycle power plant, the method comprising:
combusting fuel with compressed air to produce a gas having a water vapor content as a result of combustion;
operating a gas turbine engine to produce electrical power with the gas;
generating steam from a water supply with the gas using a steam system;
injecting steam from the steam system into the gas to increase the water vapor content;
capturing water vapor from the gas to produce captured water using a water vapor separation membrane placed in a flow of the gas;
condensing water with a condenser positioned outside of the flow of the gas;
producing a pressure differential between the condenser and water vapor separated by the water vapor separation membrane such that the separated water vapor can be drawn into the condenser;
returning a portion of the captured water to the water supply; and
exporting a remainder of the captured water to a system external to the gas turbine combined cycle power plant.

12. The method of claim 11, wherein capturing water vapor from the gas to produce captured water using a water vapor separation membrane comprises passing the gas through a water vapor separation membrane comprising a vapor-selective membrane.

13. The method of claim 11, wherein injecting steam from the steam system into the gas to increase the water vapor content comprises injecting steam generated from water recovered with the water vapor separation membrane into a combustor of the gas turbine engine.

14. (canceled)

15. The method of claim 11, wherein generating steam from the water supply with the gas using the steam system comprises generating steam with a 3-stage heat recovery steam generator having a low-pressure stage, a medium-pressure stage and a high-pressure stage, wherein steam is drawn from the medium-pressure stage for steam injection.

16. (canceled)

17. The method of claim 11, wherein generating steam from the water supply with the gas comprises generating steam with a steam injection simple cycle comprising:
a HRSG to heat water from the water supply with gas of the gas turbine engine; and
an injector to introduce steam from the HRSG into a combustor for the gas turbine engine.

18. The method of claim 11, further comprising electrolyzing hydrogen using an electrolyzer from the remainder of the captured water.

19. The method of claim 11, wherein exporting a remainder of the captured water to a system external to the gas turbine combined cycle power plant comprises sending a portion of water captured with the water vapor separation membrane to an external consumer of water.

20. The method of claim 19, wherein the external consumer of water comprises a municipality or an industrial consumer.

21. (canceled)

22. The power production facility of claim 1, wherein:
a partial water pressure in the gas is at a first pressure upstream of the vapor separation membrane; and
the condenser generates a second pressure less than the first pressure such that separated water vapor is drawn into the condenser.

23. The power production facility of claim 1, wherein:
the condenser is configured to collect water separated from the gas by the vapor separation membrane; and
the vapor separation membrane comprises a feed side having a first pressure produced by the gas and a permeate side having a second pressure produced by a vacuum pressure of the condenser, wherein the first pressure is greater than the second pressure.
